(19) United States
(12) Patent Application Publication
(10) Pub. No.: US 2007/0159467 A1
(43) Pub. Date: Jul. 12, 2007

(54) Display device and driving method thereof

(75) Inventors: Tae-Woo Kim, Seongnam-si (KR); Jong-Woung Park, Seongnam-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/592,650

(22) Filed: Nov. 3, 2006

(30) Foreign Application Priority Data
Jan. 11, 2006 (KR) 2006-03206

(51) Int. Cl. G06F 3/041

(52) U.S. Cl. 345/173

(57) ABSTRACT

A display device which includes a touch screen panel including a plurality of x-axis sensors and a plurality of y-axis sensors and outputting sensor data sensed by the x-axis and y-axis sensors in a frame unit, and a controller for receiving the sensor data to output coordinates of a contact point of the touch screen panel, wherein the controller includes a plurality of frame memories for storing the sensor data in a frame unit, a first calculation part for adding the sensor data in the frame memories to output an added value of the sensor data, a plurality of buffer memories for storing the added value of the sensor data, and a detecting part for detecting the coordinates of the contact point using the values in the buffer memories.

### CROSS-REFERENCE TO RELATED APPLICATIONS

This application claims priority to Korean Patent Application 10-2006-0003206, filed on Jan. 11, 2006, the disclosure of which is incorporated by reference herein.

### BACKGROUND OF THE INVENTION

(a) Technical Field

The present disclosure relates to a display device and, more particularly, a touch screen display device.

(b) Discussion of the Related Art

A touch screen system is a system that is configured to recognize the coordinates that correspond to a position on a touch screen touched by fingers or pens. Touch screens provide a direct interface between a user and a computing system. A touch screen display device allows a user to directly select a desired position on the screen without the aid of external input devices such as a mouse, a keyboard, and the like.

However, the reliability of a touch screen display device is greatly dependent on whether the coordinates of a position contacted by a user is exactly detected.

### SUMMARY OF THE INVENTION

An exemplary embodiment of the present invention provides a display device which comprises a touch screen panel including a plurality of x-axis sensors and a plurality of y-axis sensors and outputting sensor data sensed by the x-axis and y-axis sensors in a frame unit, and a controller for receiving the sensor data to output coordinates of a contact point of the touch screen panel, wherein the controller comprises a plurality of frame memories for storing the sensor data in a frame unit, a first calculation part for adding the sensor data in the frame memories to output the added value of the sensor data, a plurality of buffer memories for storing the added value of the sensor data, and a detecting part for detecting the coordinates of the contact point using the values in the buffer memories.

An exemplary embodiment of the present invention provides a driving method in a display device which comprises receiving sensor data from sensors of a touch screen panel in a frame unit, storing the sensor data in a frame memory in the frame unit, adding the sensor data in the frame memory to store an added value of a buffer memory, and detecting the coordinates of the contact point using the added value in the buffer memory.

### BRIEF DESCRIPTION OF THE DRAWINGS

FIG. 1 is a block diagram showing a touch screen display device according to the present invention.

FIG. 2 is a block diagram showing a controller illustrated in FIG. 1.

FIG. 3 shows data stored in frame memories illustrated in FIG. 2.

FIG. 4 shows data stored in a buffer memory part illustrated in FIG. 2.

FIG. 5 is a block diagram showing a touch event detecting part illustrated in FIG. 2.

FIG. 6 shows data calculated by a calculation part illustrated in FIG. 5.

FIG. 7 is a flowchart for describing a touch event detecting operation of a controller illustrated in FIG. 1.

FIG. 8 is a graph showing values of the second sensor data every frame.

### DETAILED DESCRIPTION OF EXEMPLARY EMBODIMENTS

The present invention will now be described more fully hereinafter with reference to the accompanying drawings, in which exemplary embodiments of the invention are shown.

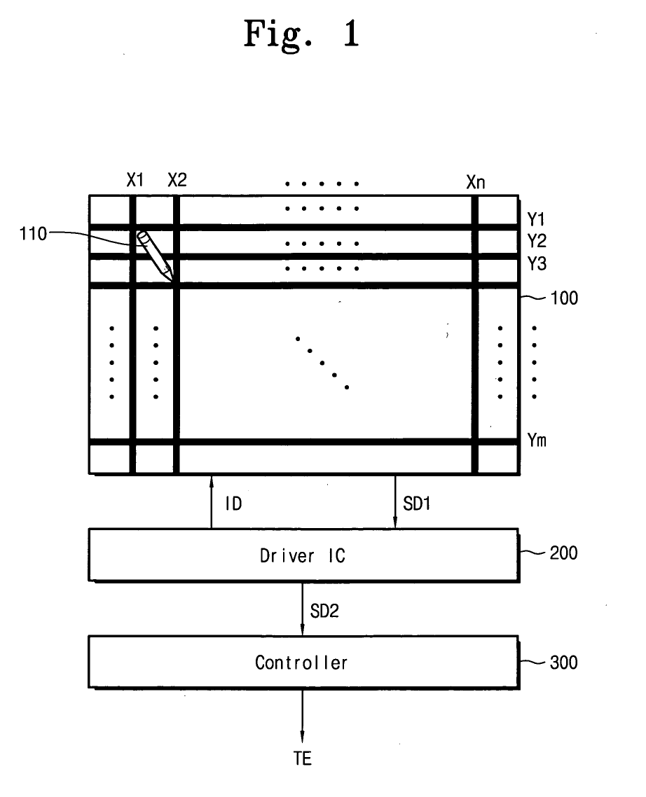

FIG. 1 is a block diagram showing a touch screen display device according to an exemplary embodiment of the present invention.

Referring to FIG. 1, the touch screen display device includes a liquid crystal panel 100, a pen 110, a driver IC 200, and a controller 300.

The liquid crystal panel 100 comprises a substrate having common electrodes and a substrate having pixel electrodes. A liquid crystal is injected between the substrates. The liquid crystal panel 100 displays an image signal by applying an electric field to the liquid crystal and adjusting the strength of the electric field to adjust the amount of light that passes through the substrate.

A plurality of X-axis sensors Y1 to Ym and a plurality of Y-axis sensors X1 to Xn are arranged in rows and columns on one substrate of the liquid crystal panel 100. The sensors X1 to Xn and Y1 to Yn of the liquid crystal panel 100 sense a point that is pressed by the pen 110, finger, or other object. The sensors X1 to Xn and Y1 to Yn output first sensor data SD1 converted into a voltage value to the driver IC 200 in a frame unit.

The driver IC 200 outputs image data ID to the liquid crystal panel 100 and is supplied with the first sensor data SD1 from the liquid crystal panel 100. The driver IC 200 supplies the controller 300 with second sensor data SD2, which is obtained by converting the first sensor data SD1 from an analog voltage value into a digital voltage value. The driver IC 200 may comprise an analog-digital converter for conversion of the analog voltage value to the digital voltage value.

The controller 300 receives the second sensor data SD2 from the driver IC 200 and determines whether the liquid crystal panel 100 is touched (or whether a touch event has occurred). If a touch has been sensed, the controller 300 obtains the coordinates of a point where the touch event occurs.

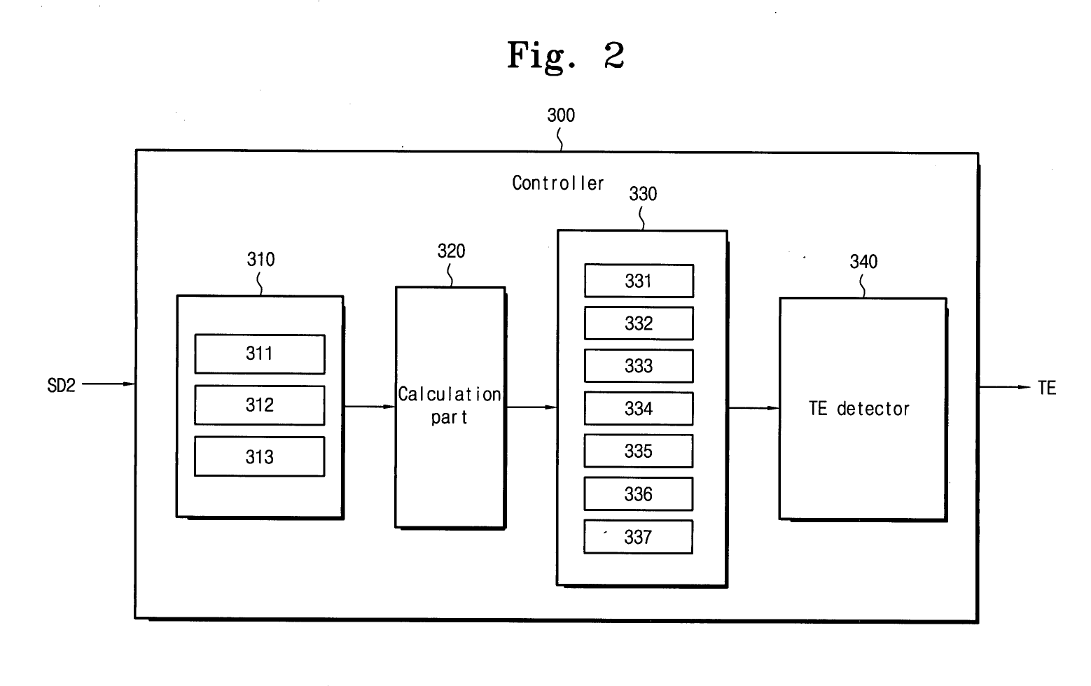

FIG. 2 is a block diagram showing a controller illustrated in FIG. 1, according to an exemplary embodiment of the present invention.

Referring to FIG. 2, a controller 300 includes a frame memory part 310, a calculation part 320, a buffer memory part 330, and a touch event detecting part 340.

The frame memory part 310 comprises a first frame memory 311, a second frame memory 312, and a third frame memory 313. The frame memory part 310 stores the second sensor data SD2 from the driver IC 200 in a frame unit. For example, the first frame memory 311 stores a value of the second sensor data SD2 that is obtained by converting a voltage value, which is sensed by the sensors X1 to Xn and Y1 to Yn with respect to a first frame, into a digital value within the driver IC 200.

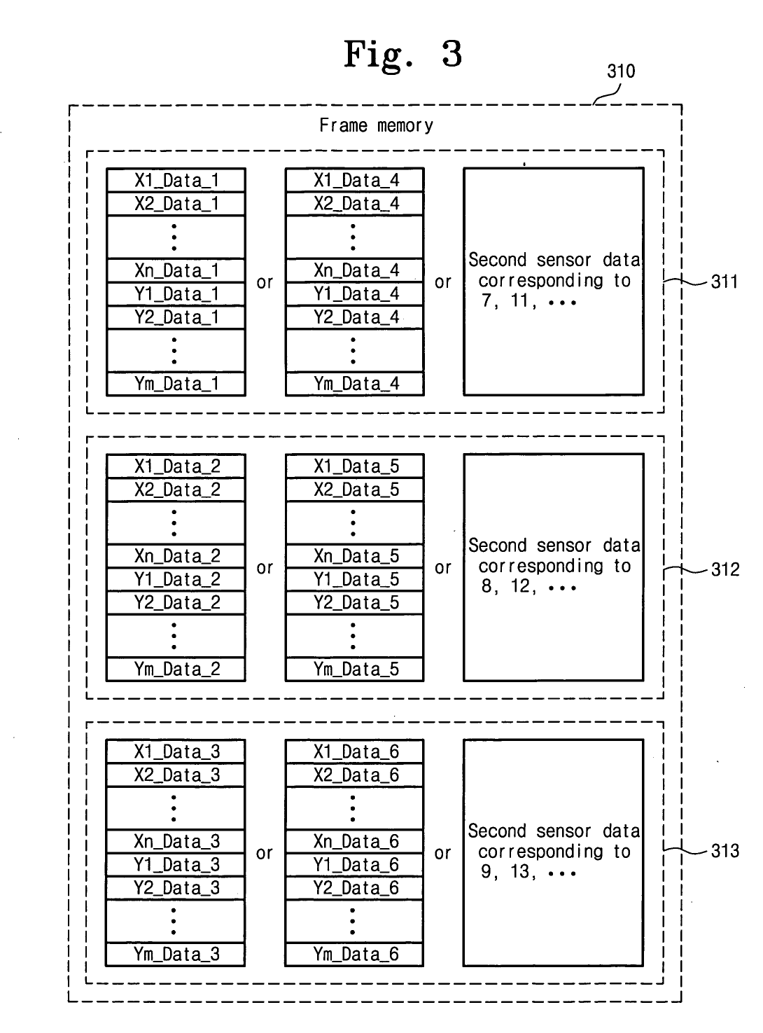

Referring to FIG. 3 which shows data stored in the frame memories 311, 312 and 313 illustrated in FIG. 2, the first frame memory 311 stores values X1_Data_1 to Xn_Data_1 of a first frame sensed by the sensors X1 to Xn and values Y1_Data_1 to Yn_Data_1 of the first frame sensed by the sensors Y1 to Yn. That is, the first frame memory 311 stores values X1_Data_1 to Xn_Data_1 and Y1_Data_1 to Yn_Data_1 of the second sensor data with respect to the first frame. Likewise, the second frame memory 312 stores values X1_Data_2 to Xn_Data_2 and Y1_Data_2 to Yn_Data_2 of the second sensor data with respect to a second frame, and the third frame memory 313 stores values X1_Data_3 to Xn_Data_3 and Y1_Data_3 to Yn_Data_3 of the second sensor data with respect to a third frame. In other words, the first to third frame memories 311, 312 and 313 store values of the second sensor data with respect to the first to third frames, respectively.

Once values of the second sensor data SD2 with respect to the first to third frames are stored in the frame memory part 310, the first frame memory 311 stores the second sensor data SD2 with respect to a fourth frame, the second frame memory 312 stores the second sensor data SD2 with respect to a fifth frame, and the third frame memory 313 stores the second sensor data SD2 with respect to a sixth frame. Likewise, if the second sensor data SD2 with respect to the fourth to sixth frames is stored in the frame memory 310, the first frame memory 311 stores the second sensor data SD2 with respect to a seventh frame, and the second and third frame memories 312 and 313 store the second sensor data SD2 with respect to eighth and ninth frames, respectively.

Returning to FIG. 2, the calculation part 320 adds and outputs the second sensor data SD2 stored in the first to third frame memories 311 to 313 in a sensor unit. For example, the calculation part 320 adds/sums data X1_Data_1 sensed by a first sensor X1 with respect to the first frame and stored in the first frame memory 311, data X1_Data_2 sensed by the first sensor X1 with respect to the second frame and stored in the second frame memory 312, and data X1_Data_3 sensed by the first sensor X1 with respect to the third frame and stored in the third frame memory 313. As an adding result, the calculation part 320 outputs a value Sum_X1_1. Likewise, the calculation part 320 adds/sums values of the second sensor data SD2 with respect to the first to third frames stored in the first to third frame memories 311 to 313 and outputs summed/added values Sum_X2_1 to Sum_Xn_1 and Sum_Y1_1 to Sum_Ym_1 to the buffer memory 330.

After values of the second sensor data SD2 are added/summed with respect to the first to third frames, the calculation part 320 adds/sums values of the second sensor data SD2 with respect to second to fourth frames in a sensor unit. That is, the calculation part 320 sums and outputs values of the second sensor data SD2 with respect to three frames in a sensor unit.

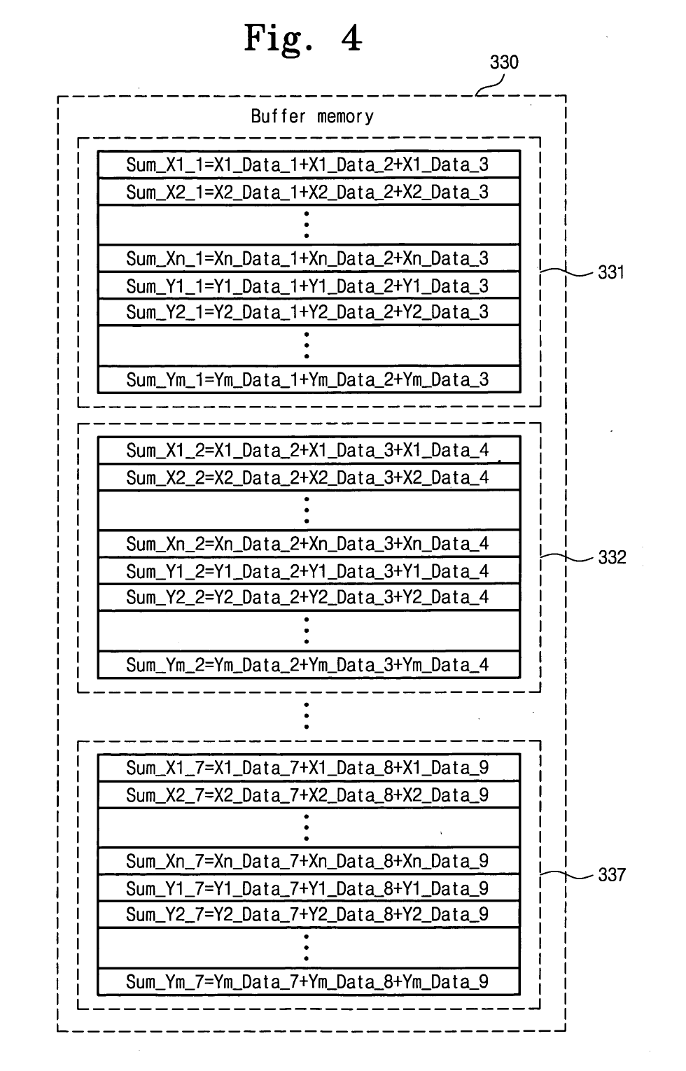

The buffer memory part 330 comprises first to seventh buffer memories 331 to 337. Referring to FIG. 4 which shows data stored in the buffer memory part 330 illustrated in FIG. 2, the first buffer memory 331 stores summed values Sum_X1_1 to Sum_Xn_1 and Sum_Y1_1 to Sum_Ym_1 with respect to the first to third frames supplied from the calculation part 320, the second buffer memory 332 stores summed values Sum_X1_2 to Sum_Xn_2 and Sum_Y1_2 to Sum_Ym_2 with respect to the second to fourth frames supplied from the calculation part 320, and the third buffer memory 333 stores summed values Sum_X1_3 to Sum_Xn_3 and Sum_Y1_3 to Sum_Ym_3 with respect to the third to fifth frames supplied from the calculation part 320. Likewise, the fourth buffer memory 334 stores summed values Sum_X1_4 to Sum_Xn_4 and Sum_Y1_4 to Sum_Ym_4 with respect to the fourth to sixth frames supplied from the calculation part 320, the fifth buffer memory 335 stores summed values Sum_X1_5 to Sum_Xn_5 and Sum_Y1_5 to Sum_Ym_5 with respect to the fifth to seventh frames supplied from the calculation part 320, and the sixth buffer memory 336 stores summed values Sum_X1_6 to Sum_Xn_6 and Sum_Y1_6 to Sum_Ym_6 with respect to the sixth to eighth frames supplied from the calculation part 320. The seventh buffer memory 337 stores summed values Sum_X1_7 to Sum_Xn_7 and Sum_Y1_7 to Sum_Ym_7 with respect to the seventh to ninth frames supplied from the calculation part 320.

The touch event detecting part 340 determines whether a touch event occurs at the liquid crystal panel 100 using values stored in the buffer memory part 330. The touch event detecting part 340 calculates the coordinates Max_ADD of a point where the touch event occurs, based on the determined result.

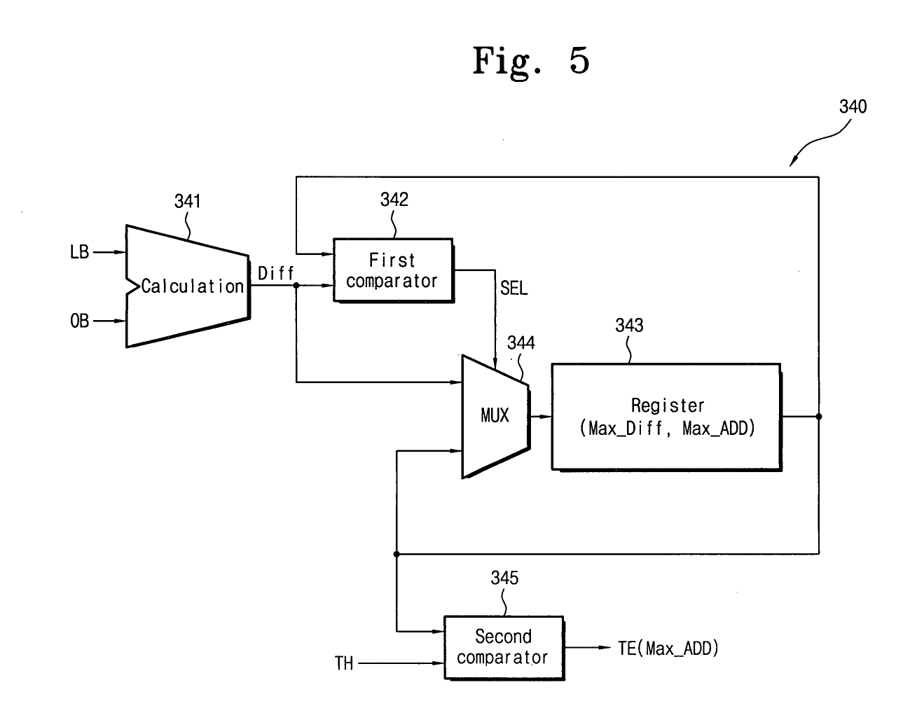

FIG. 5 is a block diagram showing a touch event detecting part illustrated in FIG. 2, according to an exemplary embodiment of the present invention.

Referring to FIG. 5, a touch event detecting part 340 comprises a calculation part 341, a first comparison part 342, a register 343, a multiplexer 344, and a second comparison part 345.

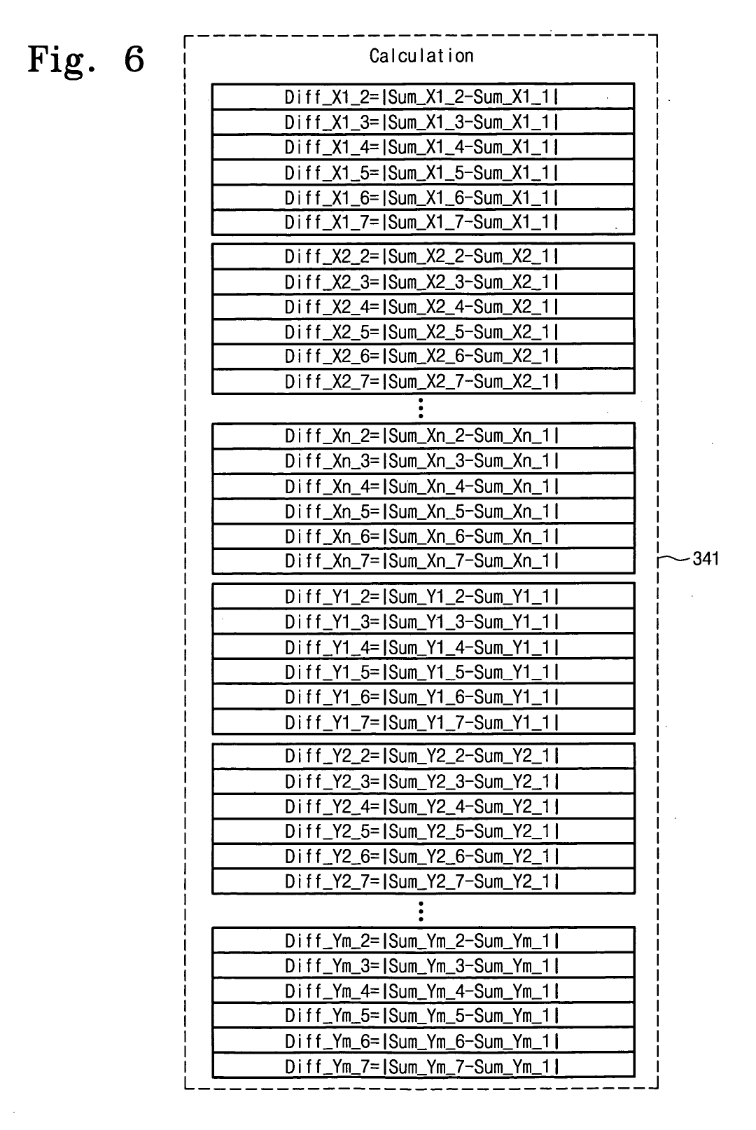

The calculation part 341 is an arithmetic logic unit (ALU) and outputs an absolute value of a result that is obtained by subtracting a value OB stored in the first buffer memory 331 and values LB stored in the second to seventh buffer memories 332 to 337. Referring to FIG. 6 which shows data calculated by the calculation part 341, the calculation part 341 calculates an absolute value of a difference between the value OB in the first buffer memory 331 and the values LB in the second to seventh buffer memories 332 to 337. The calculation part 342 can detect a touch event considering both increased and decreased values of the sensor data, by calculating an absolute value of the difference.

Returning to FIG. 5, the first comparison part 342 compares an absolute value Diff of a difference output from the calculation part 341 with a maximum difference Max_Diff output from the register 343. The first comparison part 342 outputs a selection signal SEL, which indicates whether the absolute value Diff of the difference output from the calculation part 341 is more than the maximum difference Max_Diff output from the register 343

The register 343 stores the maximum difference Max_Diff and an address Max_ADD corresponding to the maximum difference Max_Diff. The address Max_ADD corresponding to the maximum difference Max_Diff is the coordinates of a point touched on the liquid crystal panel 100.

The multiplexer 344 is supplied with the absolute value Diff of the difference from the calculation part 341 and the maximum difference Max_Diff from the register 344. The multiplexer 344 outputs either one of the absolute value Diff of the difference and the maximum difference Max_Diff in response to the selection signal SEL. For example, when the selection signal SEL indicates that the absolute value Diff of the difference is more than the maximum difference Max_Diff, the multiplexer 344 outputs the absolute value Diff of the difference. When the selection signal SEL indicates that the absolute value Diff of the difference is less than the maximum difference Max_Diff, the multiplexer 344 outputs the maximum difference Max_Diff. That is, a relatively higher value of the maximum difference Max_Diff and the absolute value Diff of the difference is selected by the first comparison part 342 and the multiplexer 344 and then stored in the register 343.

The second comparison part 345 is supplied with the maximum difference Max_Diff from the register 343 and a threshold value TH. If the maximum difference Max_Diff is more than the threshold value TH, the second comparison part 345 outputs information indicating that a touch event TE occurs. At substantially the same time, the second comparison part 345 calculates and outputs the coordinates Max_ADD corresponding to the maximum difference Max_Diff. The threshold value TH is a reference value for determining whether the liquid crystal panel 100 is touched.

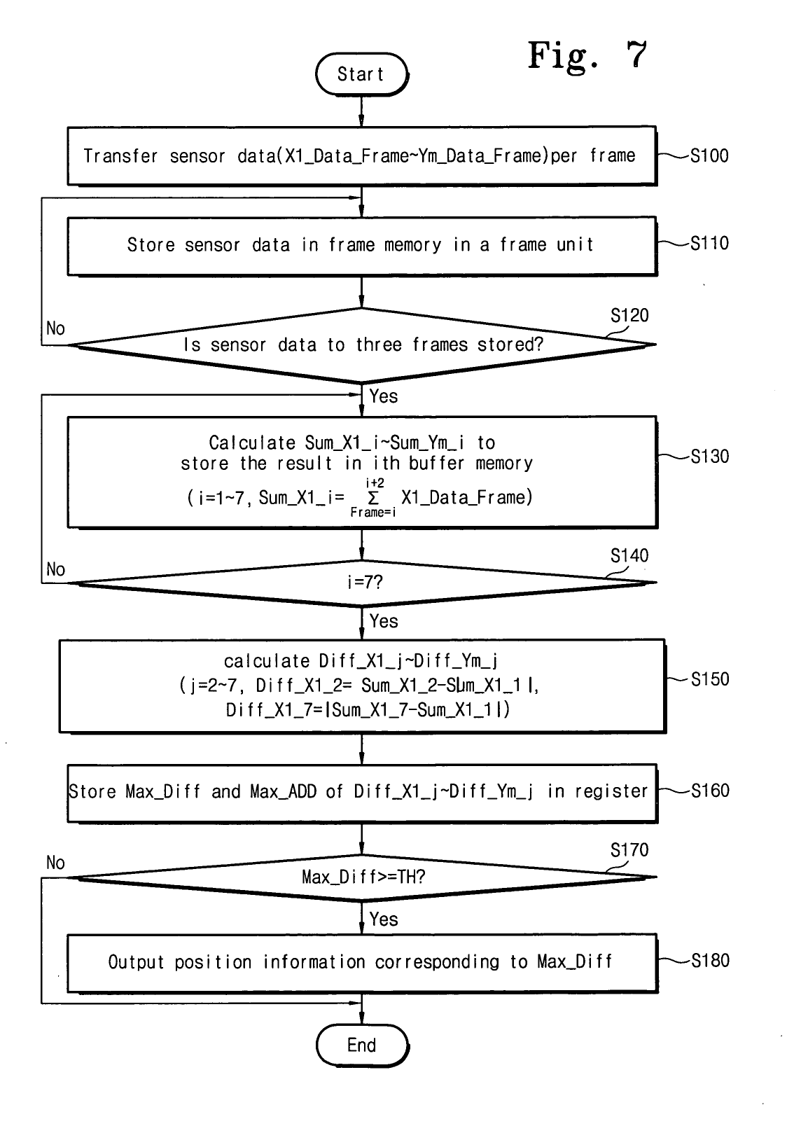

FIG. 7 is a flowchart which illustrates a touch event detecting operation of a controller illustrated in FIG. 1, according to an exemplary embodiment of the present invention.

Referring to FIG. 7, in a step S100, the sensors X1 to Xn and Y1 to Yn of the liquid crystal panel 100 sense the first sensor data SD1 per frame and output the sensed data to the driver IC 200. The driver IC 200 converts the first sensor data SD1 to a digital value and outputs the converted digital value as the second sensor data SD2 to the frame memory part 310. In a step S110, the frame memory 310 stores the second sensor data SD2 in a frame unit. In a step S120, it is determined whether values of the second sensor data SD2 with respect to three frames are stored in the first to third frame memories 311 to 313. If values of the second sensor data SD2 with respect to three frames are stored in the first to third frame memories 311 to 313, in a step S130, the calculation part 320 adds/sums the values of the second sensor data SD2 in a sensor unit and stores the added values Sum_X1_i to Sum_Ym_i in an ith buffer memory 33i (i=1 to 7). In a step S140, it is determined whether i is 7. If not, the procedure goes to step S130. If i is 7, the procedure goes to a step S140, in which the calculation part 341 outputs an absolute value Diff_X1_j to Diff_Ym_j that is obtained by subtracting a value OB stored in the first buffer memory 331 and values LB stored in the second to seventh buffer memories 332 to 337. Herein, j ranges from 2 to 7.

In a step S160, a relatively higher value of the maximum difference Max_Diff and the absolute value Diff of the difference is selected by the first comparison part 342 and the multiplexer 344 and then stored in the register 343.

In a step S170, the second comparison part 345 is supplied with the maximum difference Max_Diff from the register 343 and a threshold value TH and determines whether the maximum difference Max_Diff is more than the threshold value TH. If the maximum difference Max_Diff is more than the threshold value TH, in a step S180, the second comparison part 345 outputs information indicating that a touch event TE occurs. At substantially the same time, the second comparison part 345 calculates and outputs the coordinates Max_ADD corresponding to the maximum difference Max_Diff.

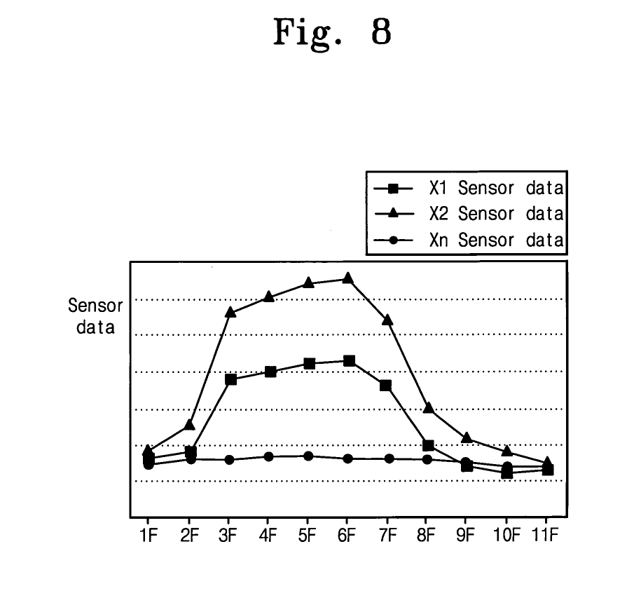

FIG. 8 is a graph showing values of the second sensor data every frame. FIG. 8 illustrates when a touch event TE occurs at the second sensor X2.

Although the present invention has been described in connection with exemplary embodiments of the present invention, it will be apparent to those skilled in the art that various modifications and changes may be made thereto without departing from the scope and spirit of the invention. Therefore, it should be understood that the above exemplary embodiments are not limitative, but illustrative in all aspects.

What is claimed is:

1. A display device comprising:
a touch screen panel including a plurality of x-axis sensors and a plurality of y-axis sensors and outputting sensor data sensed by the x-axis and y-axis sensors in a frame unit; and
a controller for receiving the sensor data to output coordinates of a contact point of the touch screen panel, wherein the controller comprises
a plurality of frame memories for storing the sensor data in a frame unit;
a first calculation part for adding the sensor data in the frame memories to output an added value of the sensor data;
a plurality of buffer memories for storing the added value of the sensor data; and
a detecting part for detecting the coordinates of the contact point using the values in the buffer memories.

2. The display device of claim 1, wherein the sensor data is a voltage value of the contact point.

3. The display device of claim 1, wherein the frame memories comprise a first frame memory, a second frame memory and a third frame memory.

4. The display device of claim 3, wherein the first calculation part adds values of the sensor data stored in the first to third frame memories.

5. The display device of claim 4, wherein the buffer memories comprise first to seventh buffer memories, each of the buffer memories storing an added value of the sensor data corresponding to an ith frame (i=1-7), a (i+1)th frame and a (i+2)th frame.

6. The display device of claim 5, wherein the detecting part comprises:
a second calculation part for outputting an absolute value obtained by subtracting an added value of the sensor data in the first buffer memory from an added value of the sensor data in the second to seventh buffer memories;
a data output part for comparing the absolute value of the subtracted result from the second calculation part with a previous maximum value to store a maximum value of the absolute values of the subtracted result and the coordinates corresponding to the maximum value; and
a first compare part for comparing the stored maximum value in the data output part with a threshold value,
the first compare part outputting the coordinates corresponding to the maximum value stored in the data output part when the maximum value is more than the threshold value.

7. The display device of claim 6, wherein the data output part comprises:
a second compare part for comparing the absolute value of the subtracted result with the previous maximum value to output a select signal;
a multiplexer for outputting a relatively higher one of the absolute value of the subtracted result and the previous maximum value in response to the select signal; and
a register for storing an output of the multiplexer and the coordinates corresponding to the output of the multiplexer.

8. The display device of claim 6, wherein the threshold value is a reference value for determining whether the touch screen panel is touched.

9. A driving method in a display device comprising:
receiving sensor data from sensors of a touch screen panel in a frame unit;
storing the sensor data in a frame memory in the frame unit;
adding the sensor data in the frame memory to store an added value in a buffer memory; and
detecting coordinates of a contact point using the added value in the buffer memory.

10. The driving method of claim 9, wherein the sensor data is a voltage value of the contact point.

11. The driving method of claim 9, wherein the frame memory comprises a first frame memory, a second frame memory and a third frame memory.

12. The driving method of claim 11, wherein the buffer memory comprises first to seventh buffer memories, each of the buffer memories storing an added value of the sensor data corresponding to an ith frame (i=1-7), a (i+1)th frame and a (i+2)th frame.

13. The driving method of claim 12, wherein the detecting comprises:
outputting an absolute value obtained by subtracting an added value of the sensor data in the first buffer memory from an added value of the sensor data in the second to seventh buffer memories;
comparing the absolute value with a previous maximum value to store a maximum value and the coordinates corresponding to the maximum value; and
comparing the stored maximum value in the data output part with a threshold value, and outputting the coordinates corresponding to the maximum value when the maximum value is more than the threshold value.

14. The driving method of claim 13, wherein the storing of the maximum value and the coordinates corresponding to the maximum value comprises:
comparing the absolute value with the previous maximum value to output a select signal;
outputting a relatively higher one of the absolute value and the previous maximum value in response to the select signal as data; and
storing the data and coordinates corresponding to the data.

15. The driving method of claim 13, wherein the threshold value is a reference value for determining whether the touch screen panel is touched.
